(19) United States
(12) Patent Application Publication
(10) Pub. No.: US 2021/0375222 A1
(43) Pub. Date: Dec. 2, 2021

(54) DISPLAY DEVICE

(71) Applicant: Japan Display Inc., Tokyo (JP)

(72) Inventor: Takeo KOITO, Tokyo (JP)

(73) Assignee: Japan Display Inc., Tokyo (JP)

(21) Appl. No.: 17/402,649

(22) Filed: Aug. 16, 2021

Related U.S. Application Data
(63) Continuation of application No. PCT/JP2019/045328, filed on Nov. 19, 2019.

(30) Foreign Application Priority Data
Feb. 19, 2019 (JP) 2019-027367

(51) Int. Cl. G09G 3/34; H04N 13/376

(52) U.S. Cl. CPC G09G 3/3426; G09G 2340/0492; G09G 2354/00; H04N 13/376

(57) ABSTRACT

According to one embodiment, a display device includes a display portion and a light control controller. Each of the sub-pixels have a first width along a first direction and a second width along a second direction, the second with being n times as large as the first width where n is a natural number of 2 or more. The light control controller extends in an oblique direction different from the first direction and the second direction and being tilted at approximately 45 degrees to the first direction.

### CROSS-REFERENCE TO RELATED APPLICATIONS

This application is a Continuation Application of PCT Application No. PCT/JP2019/045328, field Nov. 19, 2019 and based upon and claiming the benefit of priority from Japanese Patent Application No. 2019-027367, filed Feb. 19, 2019, the entire contents of all of which are incorporated herein by reference.

### FIELD

Embodiments described herein relate generally to a display device.

### BACKGROUND

In recent years, various multi-eye display devices that allow stereoscopic viewing with naked eyes have been proposed. In such a display device, it is required to enable more natural stereoscopic viewing. For example, a technique by which a light beam control element overlaid on a display device including a sub-pixel group changes its optical characteristics at a predetermined cycle along a direction forming an arctan (1/3) with a first direction is known. In addition, a technique by which the lens elements are tilted to arctan (1/12), arctan (1/15), and arctan (1/16), respectively is also disclosed.

The above-described display device realizes stereoscopic viewing in the lateral direction (horizontal direction). When the image is observed from the longitudinal direction (vertical direction), the display quality is significantly deteriorated.

### BRIEF DESCRIPTION OF THE DRAWINGS

FIG. 1 is a cross-sectional view showing a first configuration example of a display device 1 of the present embodiment.

FIG. 2 is a plan view showing a configuration example of the display panel 10 shown in FIG. 1.

FIG. 3 is a cross-sectional view showing a configuration example of the light control element 20 shown in FIG. 1.

FIG. 4 is a plan view showing a configuration example of the light control element 20 shown in FIG. 3.

FIG. 5 is a cross-sectional view showing a second configuration example of the display device 1 of the present embodiment.

FIG. 6 is a cross-sectional view showing a third configuration example of the display device 1 of the embodiments.

FIG. 7 is a cross-sectional view showing a configuration example of a light control element 60.

FIG. 8 is a plan view showing a configuration example of the light control element 60.

FIG. 9 is a plan view showing an example of a layout of the sub-pixels SP in a state in which the display portion DA is in lateral orientation.

FIG. 10 is a diagram showing a relationship between a viewpoint on a virtual observation plane VP and observed sub-pixels SP.

FIG. 11 is a plan view showing an example of the layout of the sub-pixels SP in a state in which the display portion DA is in longitudinal orientation.

FIG. 12 is a diagram illustrating movement of the observer's line of sight.

FIG. 13 is a diagram showing a relationship between a first display mode and the observer's line of sight.

FIG. 14 is a diagram showing a relationship between a second display mode and the observer's line of sight.

FIG. 15 is a diagram illustrating a tilt angle θ3 of a light control controller 100 to the display portion DA.

FIG. 16 is a table showing a relationship between the tilt angle θ3 of the light control controller 100 and moire.

FIG. 17 is a diagram illustrating lateral observation.

FIG. 18 is a diagram illustrating longitudinal observation.

FIG. 19 is a block diagram showing a configuration of a display system.

FIG. 20 is a flowchart illustrating the operation of the display device 1 according to the mode switching method 1.

FIG. 21 is a flowchart illustrating the operation of the display device 1 according to a mode switching method 2.

FIG. 22 is a flowchart illustrating the operation of the display device 1 according to the mode switching method 3.

### DETAILED DESCRIPTION

In general, according to one embodiment, a display device includes a display portion including a plurality of sub-pixels arranged in a first direction and a second direction orthogonal to the first direction; and a light control controller overlaid on the display portion to control a light beam emitted from each of the sub-pixels. Each of the sub-pixels have a first width along the first direction and a second width along the second direction, the second with being n times as large as the first width where n is a natural number of 2 or more. The light control controller extends in an oblique direction different from the first direction and the second direction and being tilted at approximately 45 degrees to the first direction.

Several embodiments will be described hereinafter with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

### First Configuration Example

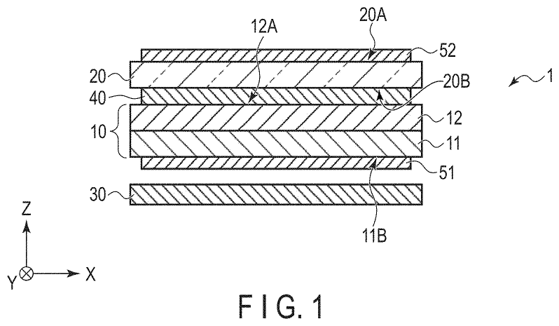

FIG. 1 is a cross-sectional view showing a first configuration example of a display device 1 of the present embodiment. In the drawing, a first direction X and a second direction Y are orthogonal to each other, and a third direction Z is orthogonal to the first direction X and the second direction Y. The first direction X and the second direction Y correspond to the directions parallel to the surface of a substrate which configures the display device 1, and the third direction Z corresponds to the thickness direction of the display device 1.

In the present specification, a direction from a first substrate 11 to a second substrate 12 is referred to as an upward direction (or, more simply, upwardly) and a direction from the second substrate 12 to the first substrate 11 is referred to as a downward direction (or, more simply, downwardly). According to “a second member on/above a first member” and “a second member under/below a first member”, the second member may be in contact with the first member or may be remote from the first member. In addition, an observation position at which the display device 1 is observed is assumed to be located on the tip side of the arrow indicating the third direction Z, and viewing from the observation position toward the X-Y plane defined by the first direction X and the second direction Y is referred to as a planar view.

The display device 1 comprises a display panel 10, a light control element 20, and an illumination device 30. The display panel 10 is, for example, a liquid crystal panel. The display panel 10 comprises a first substrate 11 and a second substrate 12. The second substrate 12 is located on the first substrate 11. The light control element 20 is located on the display panel 10. The light control element 20 comprises a plurality of light control controllers, which will be described later in detail. The light control element 20 is fixed to the display panel 10 with a transparent resin 40. The illumination device 30 is located under the display panel 10. A first polarizer 51 is adhered to a lower surface 11B of the first substrate 11. A second polarizer 52 is adhered to an upper surface 20A of the light control element 20.

The second polarizer 52 may be adhered to an upper surface 12A of the second substrate 12 or a lower surface 20B of the light control element 20. In addition, the light control element 20 may be located between the first polarizer 51 and the first substrate 11 or between the illumination device 30 and the first polarizer 51. In addition, the light control element 20 may be built in the display panel 10.

Incidentally, the display panel 10 is not limited to a liquid crystal panel, but may be a self-luminous display panel comprising organic electroluminescent display devices, _{P}LED or the like, or an electronic paper-type display panel comprising electrophoretic elements or the like.

The display panel 10 is, for example, a transmissive display panel that displays an image by selectively transmitting light from a back surface side of the first substrate 11. Incidentally, the display panel 10 may be a reflective display panel that displays an image by selectively reflecting light from a front surface side of the second substrate 12 or a display panel comprising both the transmissive display function and the reflective display function. When the display panel 10 is a reflective display panel, the illumination device 30 may be omitted or the illumination device 30 may be located on the display panel 10.

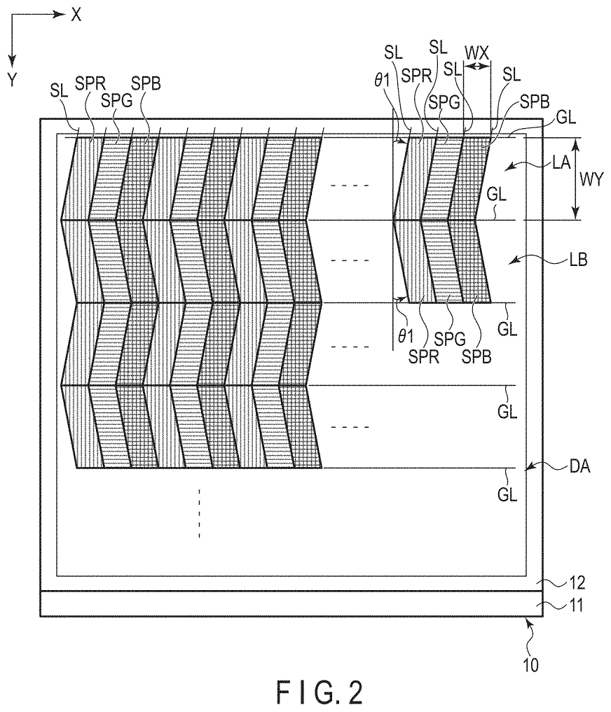

FIG. 2 is a plan view showing a configuration example of the display panel 10 shown in FIG. 1. The display panel 10 comprises a display portion DA at a part where the first substrate 11 and the second substrate 12 are overlaid in planar view. The display portion DA comprises a plurality of pixels SP arrayed in a matrix in the first direction X and the second direction Y. For example, the display portion DA comprises, as the sub-pixels SP, a red sub-pixel SPR that displays a red color, a green sub-pixel SPG that displays a green color, and a blue sub-pixel SPB that displays a blue color.

In FIG. 2, the red sub-pixel SPR is represented by a vertical line pattern parallel to the second direction Y, the green sub-pixel SPG is represented by a horizontal line pattern parallel to the first direction X, and the blue sub-pixel SPB is represented by a grating pattern. In the following descriptions, when the color of the sub-pixel is not mentioned, the sub-pixel may be simply referred to as the sub-pixel SP.

In addition, when the X-Y plane of the display portion DA has a rectangular shape, a shorter side direction is the first direction X and a longer side direction is the second direction Y. That is, when the shorter side direction of the display portion DA is the horizontal direction and the longer side direction of the display portion DA is the vertical direction, the first direction X may be referred to as the horizontal direction and the second direction Y may be referred to as the vertical direction. The plurality of sub-pixels SP arranged in the first direction X form a “row”, and the plurality of sub-pixels SP arranged in the second direction Y form a “column”.

Two sub-pixels SP adjacent to each other in the first direction X correspond to sub-pixels that display colors different from each other. Two sub-pixels SP adjacent to each other in the second direction Y correspond to the sub-pixels that display the same color. In the example shown in FIG. 2, the red sub-pixel SPR, the green sub-pixel SPG, and the blue sub-pixel SPB are arranged in this order in the first direction X, and the sub-pixels SP of the same color are arranged in the second direction Y.

The red sub-pixel SPR, the green sub-pixel SPG, and the blue sub-pixel SPB are each formed in a parallelogram, and are tilted to the second direction Y at an angle θ1 of 4 degrees or more and 16 degrees or less. In addition, the red sub-pixel SPR, the green sub-pixel SPG, and the blue sub-pixel SPB have the same dimensions, and have a first width WX along the first direction X and a second width WY along the second direction Y. The second width WY is larger than the first width WX. The first width WX corresponds to a pitch of the sub-pixels SP along the first direction X and also corresponds to a pitch of the adjacent signal lines SL along the first direction X. The second width WY corresponds to a pitch of the sub-pixels SP along the second direction Y and also corresponds to a pitch of the adjacent scanning lines GL along the second direction Y.

For example, when n-color sub-pixels are arranged in the first direction X and a set of these n sub-pixels is arranged in the first direction X, the second width WY is n times as large as the first width WX. n is a natural number of 2 or more. In the example shown in FIG. 2, n is 3. For this reason, the second width WY is approximately three times as large as the first width WX.

In the display portion DA, the sub-pixels SP located in the odd-numbered rows LA are tilted in a different direction from the sub-pixels SP located in the even-numbered rows LB. However, the angle formed by the sub-pixels SP located in the odd-numbered rows LA and the second direction Y is the same as the angle formed by the sub-pixels SP located in the even-numbered rows LB and the second direction Y.

For example, each of the sub-pixels SP located in the odd-numbered rows LA is tilted clockwise to the second direction Y at an angle θ1. In contrast, each of the sub-pixels SP located in the even-numbered rows LB is tilted counterclockwise to the second direction Y at the angle θ1. Incidentally, the sub-pixels SP located in the odd-numbered rows LA may be tilted counterclockwise to the second direction Y at the angle θ1, and the sub-pixels SP located in the even-numbered rows LB may be tilted clockwise to the second direction Y at the angle θ1.

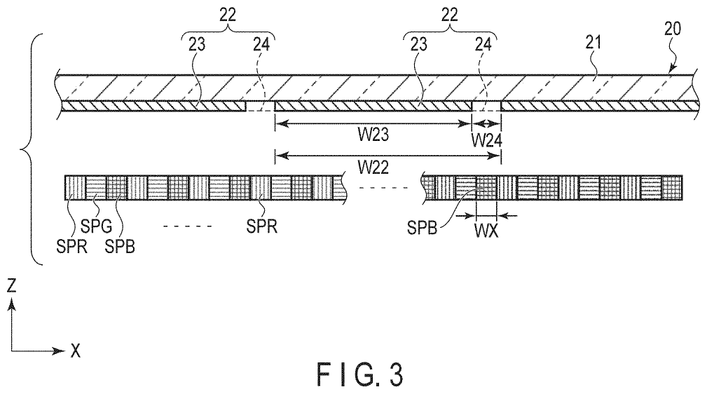

FIG. 3 is a cross-sectional view showing a configuration example of the light control element 20 shown in FIG. 1. The light control element 20 comprises a base 21 and a plurality of light regulators 22. The base 21 is a transparent substrate of glass or resin. The light regulators 22 limit the light beams that are transmit through themselves, and function as light control controllers. For example, the light regulator 22 comprises a light shield 23 overlaid on the plurality of sub-pixels SP arranged in the first direction X, and an opening 24 overlaid on at least one sub-pixel SP. In other words, the plurality of light shields 23 are arranged in the first direction X at intervals corresponding to the widths of the openings 24. An optical density (OD value) of the light shields 23 is desirably 3 or more. The light shields 23 may be light absorbing members or light reflecting members. The light shields 23 may be formed of a metal material such as a compound containing chromium, molybdenum, or silver or may be formed of a black resin material. In the present embodiment, for example, an emulsion mask is used as the light regulators 22.

The light shield 23 has a width W23 and the opening 24 has a width W24. Incidentally, each of the widths W23 and W24 is a length along the first direction X. The width W22 of one light regulator 22 or a pitch of the light regulators 22 arranged in the first direction X corresponds to the sum of the width W23 and the width W24.

The width W23 is larger than the width W24. For example, two light regulators 22 arranged in the first direction X are overlaid on twenty-three sub-pixels SP. The openings 24 adjacent to each other in the first direction X are overlaid on the sub-pixels SP of different colors. For example, the opening 24 located on the left side of FIG. 3 is overlaid on the red sub-pixel SPR, and the opening 24 located on the right side of FIG. 3 is overlaid on the blue sub-pixel SPB.

In the example shown in FIG. 3, the width W24 is larger than the first width WX of the sub-pixel SP, but is not limited to this example. The width W24 may be equal to the first width WX or the width W24 may be smaller than the first width WX. When the width W24 is smaller than the first width WX, the number of light beams transmitted through the opening 24 can be reduced, and the resolution of a visually recognized image can be improved. In contrast, from the viewpoint of suppressing the reduction in the luminance of the visually recognized image, the width W24 is desirably set to be substantially equal to the first width WX for at least one sub-pixel. In addition, one opening 24 may be overlaid on a plurality of sub-pixels SP.

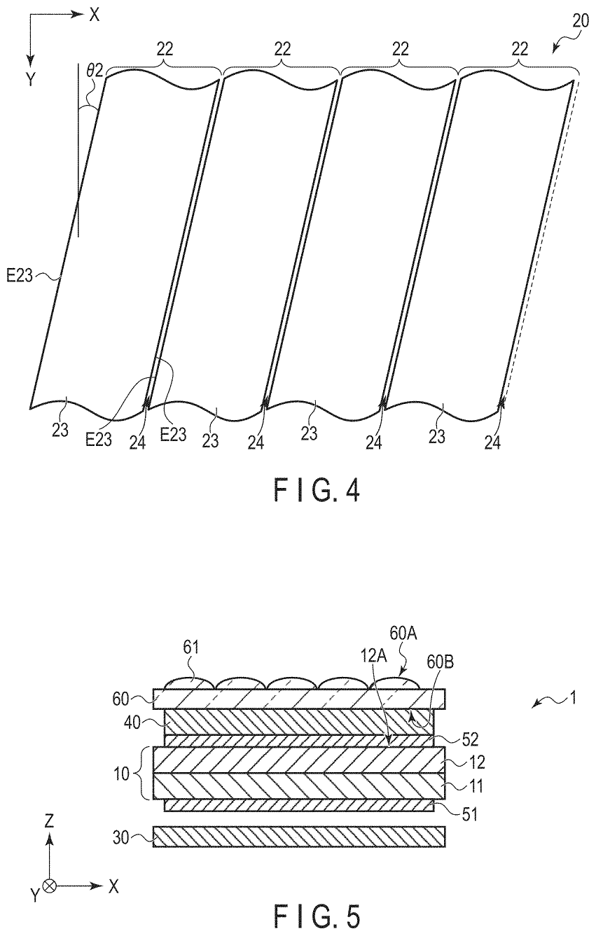

FIG. 4 is a plan view showing a configuration example of the light control element 20 shown in FIG. 3. In the light control element 20, the plurality of light regulators 22 are arranged in the first direction X. The light shield 23 and the opening 24 that constitute the light regulator 22 extend in an oblique direction different from the first direction X and the second direction Y. Each of the light shields 23 has a pair of edges E23 arranged in the first direction X. The pair of edges E23 are parallel to each other. The opening 24 is located between the facing edges E23 of the light shields 23 adjacent to each other in the first direction X.

The light regulators 22 are overlaid on the display portion DA shown in FIG. 2 and linearly extend across the sub-pixels SP located in the odd-numbered rows LA and the sub-pixels SP located in the even-numbered rows LB. Each of the light regulators 22, the light shields 23, and the openings 24 is tilted to the second direction Y at an angle θ2. The angle θ2 is smaller than the angle θ1. In the embodiments, the extending direction of each of the light regulators 22, the light shields 23, and the openings 24 can be defined as the extending direction of the edge E23. The edge E23 is tilted to the second direction Y at the angle θ2.

In addition, as described later, when the first direction X is used as a reference, the edge E23 is tilted to the first direction X at an angle θ3. This angle θ3 is set to an angle at which the image displayed on the display portion DA can be stereoscopically viewed in two orthogonal directions, i.e., the first direction X and the second direction Y, and is approximately 45 degrees. Incidentally, the angle θ3 may be an angle clockwise to the first direction X or may be an angle counterclockwise to the first direction X.

### Second Configuration Example

FIG. 5 is a cross-sectional view showing a second configuration example of the display device 1 of the present embodiment. The display device 1 shown in FIG. 5 comprises a light control element 60 different from the display device 1 shown in FIG. 1. The light control element 60 comprises a plurality of lenses 61. The light control element 60 has a lens surface 60A and a flat surface 60B. The light control element 60 is arranged such that the flat surface 60B faces the display panel 10. The light control element 60 is fixed by a transparent resin 40 between the flat surface 60B and the second polarizer 52. The second polarizer 52 is adhered to the upper surface 12A of the second substrate 12. Details of the light control element 60 will be described later.

### Third Configuration Example

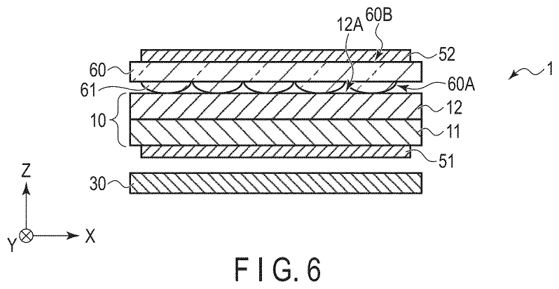

FIG. 6 is a cross-sectional view showing a third configuration example of the display device 1 of the embodiments. The display device 1 shown in FIG. 6 is different from the display device 1 shown in FIG. 5 with respect to the position of the light control element 60. That is, the lens surface 60A of the light control element 60 is in contact with the second substrate 12. The light control element 60 is desirably fixed to the outer periphery of the display panel 10, though not described in detail. The second polarizer 52 is adhered to the flat surface 60B of the light control element 60. Details of the light control element 60 will be described later.

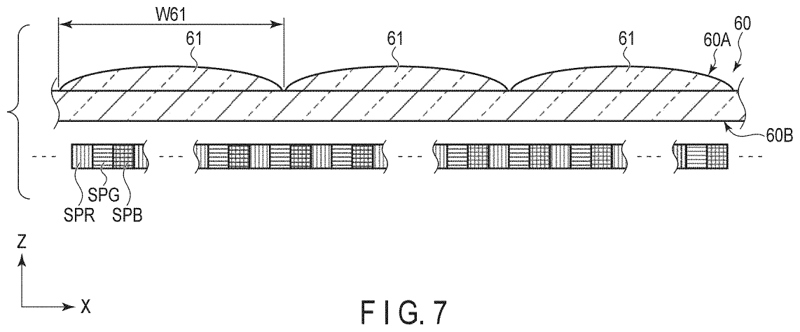

FIG. 7 is a cross-sectional view showing a configuration example of a light control element 60. The light control element 60 of the second configuration example shown in FIG. 5 will be exemplified here. The light control element 60 comprising the plurality of lenses 61 is formed of transparent glass or resin. The lenses 61 function as light control controllers. The lenses 61 are overlaid on the plurality of sub-pixels SP arranged in the first direction X. The sub-pixels SP shown in the figure are provided in the display panel 10 shown in FIG. 5. The lens 61 has a width W61 along the first direction X. For example, two lenses 61 arranged in the first direction X are overlaid on twenty-three sub-pixels SP.

Incidentally, in the example shown in FIG. 7, the flat surface 60B of the light control element 60 is opposed to the sub-pixels SP, but the lens surface 60A of the light control element 60 may be opposed to the sub-pixels SP as described in the third configuration example shown in FIG. 6.

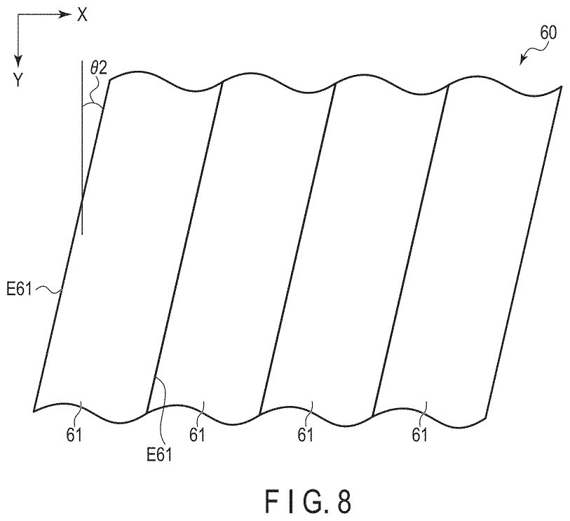

FIG. 8 is a plan view showing a configuration example of the light control element 60. The light control element 60 shown in this figure is applicable to both the second configuration example shown in FIG. 5 and the third configuration example shown in FIG. 6. In the light control element 20, the plurality of lenses 61 are arranged in the first direction X. The lenses 61 extend in a direction different from the first direction X and the second direction Y. Each of the lenses 61 has a pair of edges E61 arranged in the first direction X. The pair of edges E61 are parallel to each other.

The lenses 61 are overlaid on the display portion DA shown in FIG. 2 and linearly extend across the sub-pixels SP located in the odd-numbered rows LA and the sub-pixels SP located in the even-numbered rows LB. The lenses 61 are tilted at the angle θ2 to the second direction Y, similarly to the first configuration example. In the embodiments, the extending direction of the lenses 61 can be defined as the extending direction of the edges E61. The edges E61 are tilted to the first direction X at the angle θ3.

### Concrete Example of Light Control

The above-described light regulators 22 and lenses 61 will be described below as the light control controllers 100. The light control controllers 100 control light beams emitted from each of the sub-pixels SP.

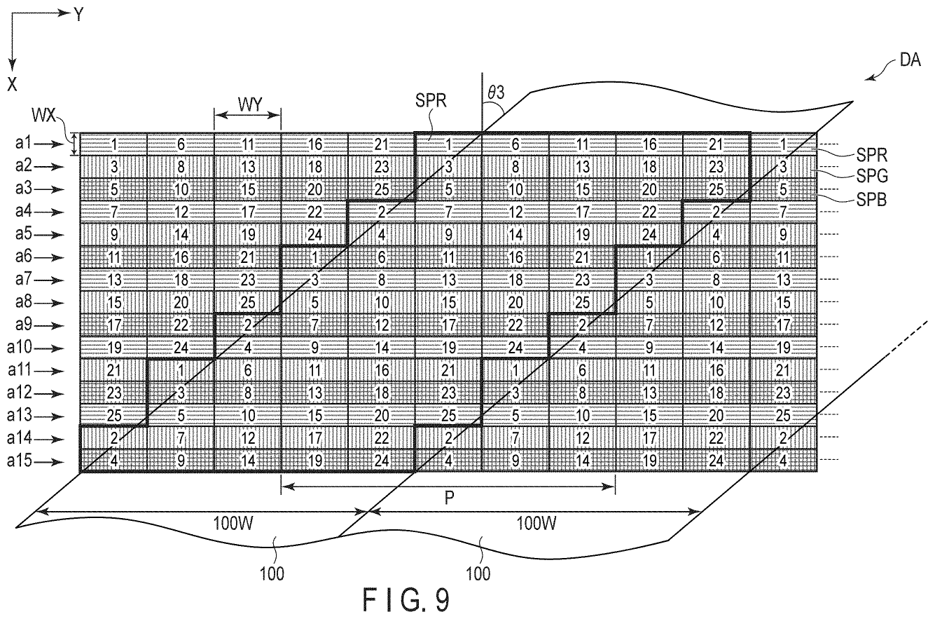

FIG. 9 is a plan view showing an example of a layout of the sub-pixels SP in a state in which the display portion DA is in lateral orientation. The “lateral orientation” means a state in which the first direction X of the display portion DA is assumed as a vertical direction and the second direction Y is assumed as a horizontal direction and is a state formed by rotating the state of FIG. 2 at 90 degrees.

The display portion DA comprises a pixel group G surrounded by a thick line in the figure. The pixel group G includes a plurality of sub-pixels SP to display an image of an L viewpoint. L is a natural number of 2 or more. In the example shown in FIG. 9, each sub-pixel SP is formed in a rectangular shape having a longer side along the second direction Y. Incidentally, the sub-pixel SP may be formed in the other shape. The viewpoint described here, which will be described later with reference to FIG. 11, indicates observation positions arranged in order in the counterclockwise direction on the observation plane VP. In FIG. 9, the number written in each of the sub-pixels SP indicates the viewpoint number.

In the pixel group G, the plurality of sub-pixels SP are arranged in a matrix in the first direction X and the second direction Y. For example, L is 25 and, when three sub-pixels SP of the red sub-pixel SPR, the green sub-pixel SPG, and the blue sub-pixel SPB are present per viewpoint, the pixel group G includes seventy-five (75=25*3) sub-pixels SP. In the pixel group G, two, five, seven, ten, twelve, or thirteen sub-pixels SP are arranged along the first direction X, and five sub-pixels SP are arranged along the second direction Y.

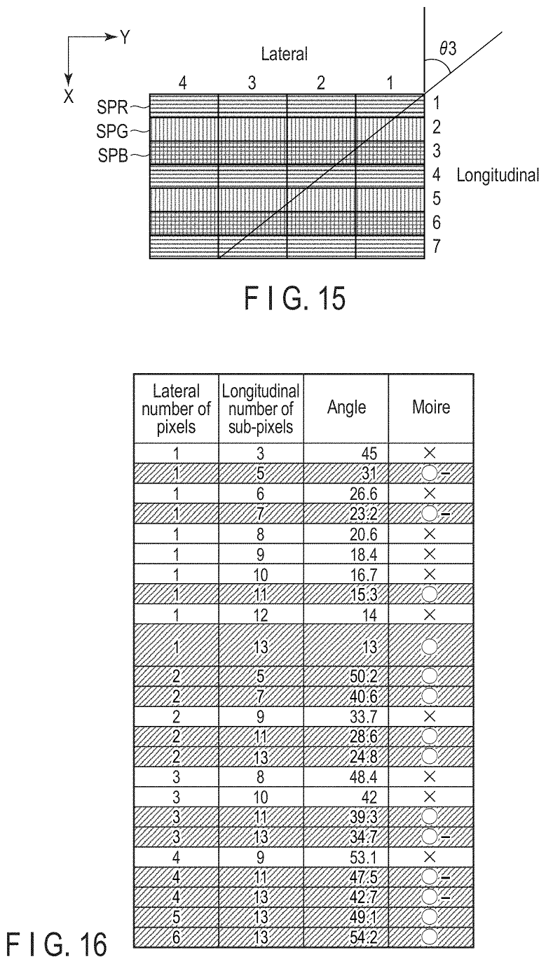

In the embodiments, one light control controller 100 arranged in the second direction Y is overlaid on one pixel group G. The light control controller 100 is tilted to the first direction X at the angle θ3. In the example of FIG. 9, θ3=arctan (6/5)=approximately 50 degrees. The angle θ3 will be described later in detail with reference to FIG. 15 and FIG. 16.

In FIG. 9, the pitch P of the adjacent light control controllers 100 is substantially the same as the width 100W of the light control controllers 100 along the second direction Y. In the example shown in

FIG. 9, the red sub-pixels SPR, the green sub-pixels SPG, and the blue sub-pixels SPB have substantially the same second width WY. However, the red sub-pixels SPR, the green sub-pixels SPG, and the blue sub-pixels SPB may not have the same width along the second direction Y. In such a case, the second width WY is defined as an average value of the widths of the red sub-pixels SPR, the green sub-pixels SPG, and the blue sub-pixels SPB along the second direction Y (or an average value of the widths along the second direction Y, of all the sub-pixels SP arranged in the second direction Y in the display portion DA).

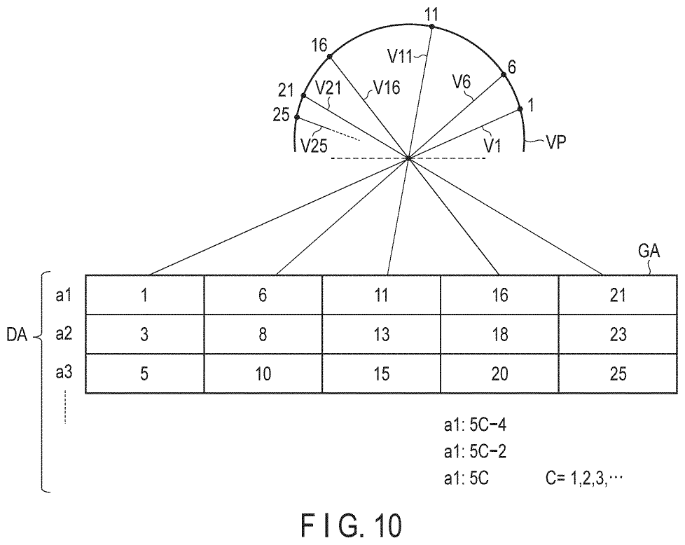

FIG. 10 is a diagram showing a relationship between a viewpoint on a virtual observation plane VP and observed sub-pixels SP. FIG. 10 corresponds to a diagram showing a relationship between the light control controller 100 and each sub-pixel SP of the pixel group G. For example, L is 25 as described above and, on the observation plane VP, twenty-five viewpoints “1” to “25” exist and lines of sight V1 to V25 corresponding to these viewpoints “1” to “25” respectively exist.

In the example of FIG. 10, representative viewpoints “1”, “6”, . . . “21” are shown, and the lines of sight V1, V6, . . . V21 corresponding to these viewpoints “1”, “6”, . . . “21” respectively are shown. The lines of sight V1, V6, . . . V21 can be regarded as light beams regulated by the light control controller 100. The lines of sight V1, V6, . . . V21 are line segments that connect the viewpoints “1”, “6”, . . “21” with the sub-pixels SP of the the first row a1, respectively, when the observer's eyes are positioned at the respective viewpoints of the observation plane VP.

Incidentally, the viewpoints “2” to “5” (not shown) exist between the viewpoints “1” and “6” on the observation plane VP. In addition, lines of sight V2 to V5 (not shown) exist between the lines of sight V1 and V6. The line of sight V2 is a line segment that connects the viewpoint “2” to the sub-pixel SP represented as “2” in the fourth row a4. The line of sight V3 is a line segment that connects the viewpoint “3” to the sub-pixel SP represented as “3” in the second row a2. The line of sight V4 is a line segment that connects the viewpoint “4” to the sub-pixel SP represented as “4” in the fifth row a5. The line of sight V5 is a line segment that connects the viewpoint “5” to the sub-pixel SP represented as “5” in the third row a3.

The sub-pixel SP observed from the viewpoint represented as (5c-4) is arranged in the first row a1. In this example, c is an integer of 1 or more. The sub-pixel SP observed from the viewpoint represented as (5c-2) is arranged in the second row a2. In the third row a3, the sub-pixel SP observed from the viewpoint represented as 5c is arranged.

As described above, twenty-five viewpoints “1” to “25” exist on the viewing surface VP, twenty-five sub-pixels SP represented as “1” to “25” exist on the display portion DA, and twenty-five corresponding lines of sight V1 to V25 exist between the observation plane VP and the display portion DA.

Returning to FIG. 9 again, the layout of the sub-pixels SP will be described.

In FIG. 9, sub-pixels SP represented as the same numbers correspond to sub-pixels observed from the same viewpoint. The pixel group G includes a total of twenty-five sub-pixels SP in five rows that are continuously arranged in the first direction X. These twenty-five sub-pixels SP are observed from twenty-five different viewpoints.

The first row a1, the sixth row a6, and the eleventh row a11 include sub-pixels SP that are arranged in a similar manner. Each of the sub-pixels SP in the first row a1, the sixth row a6, and the eleventh row a11 displays an image corresponding to the viewpoint represented as (5c-4) in the pixel group G.

The second row a2, the seventh row a7, and the twelfth row a12 include sub-pixels SP that are arranged in a similar manner. Each of the sub-pixels SP in the second row a2, the seventh row a7, and the twelfth row a12 displays an image corresponding to the viewpoint represented as (5c-2) in the pixel group G.

The third row a3, the eighth row a8, and the thirteenth row a13 include the sub-pixels SP that are arranged in a similar manner. Each of the sub-pixels SP in the third row a3, the eighth row a8, and the thirteenth row a13 displays an image corresponding to the viewpoint represented as 5c in the pixel group G.

The sub-pixels SP for three consecutive rows include any of the red sub-pixels SPR, the green sub-pixels SPG, and the blue sub-pixels SPB observed at the same viewpoint. In addition, to realize color display from the same viewpoint, the sub-pixels SP of nine continuous rows include all of the red sub-pixels SPR, the green sub-pixels SPG, and the blue sub-pixels SPB.

That is, the sub-pixels of the first color observed from the same viewpoint are included from the first row a1 to the fifth row a5, the sub-pixels of the second color different from the first color are included from the sixth row a6 to the tenth row a10, and the sub-pixels of the third color different from the first color and the second color are included from the eleventh row a11 to the fifteenth row a15. For example, when observed from the viewpoint “1”, the red sub-pixel SPR is included in the first row a1, the blue sub-pixel SPB is included in the sixth row a6, and the green sub-pixel SPG is included in the eleventh row a11. The red sub-pixel SPR, the green sub-pixel SPG, and the blue sub-pixel SPB that display images of the same viewpoint are arranged in a direction in which the edge 100E of the light control controller 100 extends.

Thus, the plurality of sub-pixels SP arranged in the second direction Y display an image when observed from the corresponding viewpoint. The observer located on the observation plane VP can visually recognize the sub-pixels SP through any of the lines of sight V1 to V25 when observing the display portion DA via the light control controller 100. The observer's right eye and left eye have different viewpoints on the observation plane VP. For this reason, the observer can recognize the parallax by observing different images from a plurality of viewpoints and obtain a stereoscopic effect of the image. In addition, when the observer changes the viewpoint along the observation plane VP, the observer can observe images corresponding to each of twenty-five viewpoints and obtain a more natural stereoscopic effect.

### Image Correction

In the example of the display portion DA shown in FIG. 9, if the viewing angle W in the lateral direction (horizontal direction) is 50 degrees, the angle between light beams in the lateral direction is approximately 2 degrees and the angle between light beams in the longitudinal direction (vertical direction) is approximately 1.4 degrees. That is, since the light beam is deviated in the lateral direction and the longitudinal direction, the image is desirably corrected in accordance with this deviation. Accordingly, a stereoscopic image having a lateral motion parallax and a stereoscopic image having a longitudinal motion parallax can be observed on the display portion DA by not changing the orientation of the display portion DA but simply switching the images.

### Longitudinal Orientation of Display Portion

FIG. 11 is a plan view showing an example of the layout of the sub-pixels SP in a state in which the display portion DA is in longitudinal orientation. The “longitudinal orientation” is a state in which the first direction X of the display portion DA is the horizontal direction and the second direction Y is the vertical direction as shown in the example of FIG. 2.

As shown in FIG. 11, even when the display portion DA is in the “longitudinal orientation”, the relationship between the pixel group G surrounded by the thick line in the figure and the light control controller 100 is the same as that in the case of the “lateral orientation”. That is, the pixel group G includes a plurality of sub-pixels SP for displaying an image of L viewpoint (N=25 in this case), and the light control controller 100 is overlaid on the pixel group G. The light control controller 100 is tilted to the first direction X at the angle θ3. Thus, a stereoscopic image having a lateral motion parallax and a stereoscopic image having a longitudinal motion parallax can be observed on the display portion DA by simply exchanging the images.

### Display mode

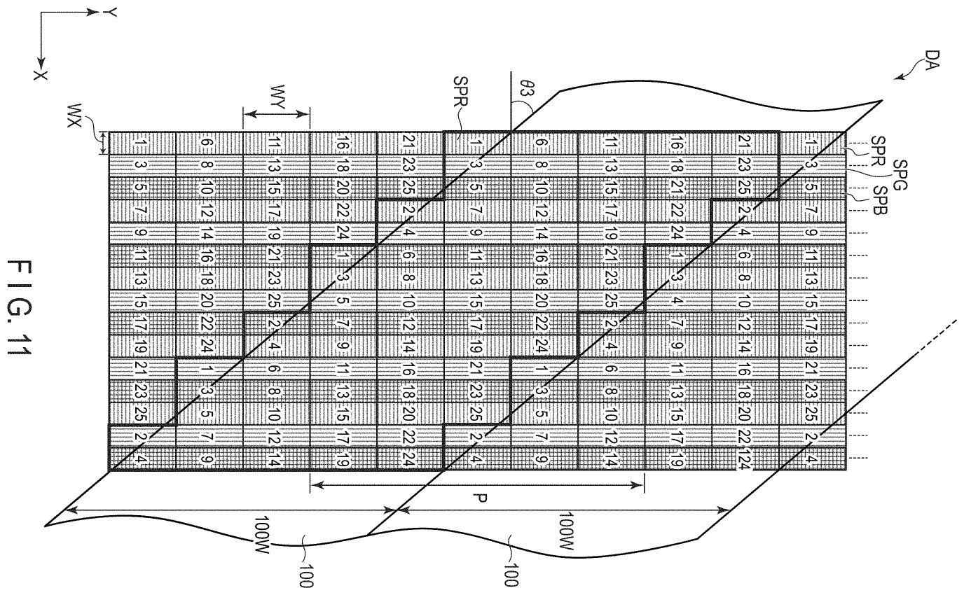

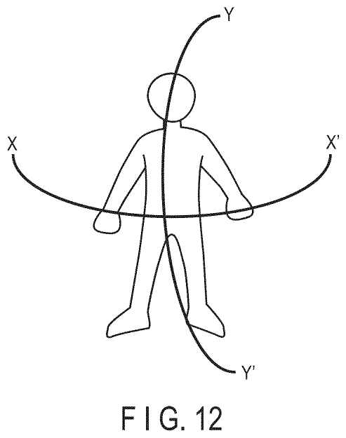

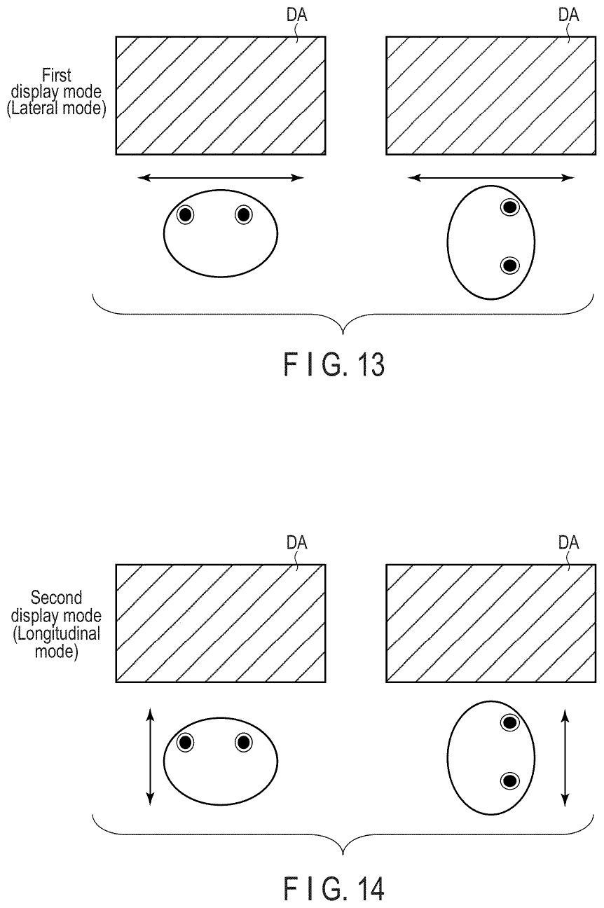

FIG. 12 is a diagram illustrating movement of the observer's line of sight. FIG. 13 is a diagram showing a relationship between a first display mode and the observer's line of sight. FIG. 14 is a diagram showing a relationship between a second display mode and the observer's line of sight.

In the embodiments, the display device 1 has a first display mode and a second display mode as modes for displaying a stereoscopic image as shown in FIG. 12. In the first display mode, as shown in FIG. 13, a stereoscopic image having a lateral motion parallax can be observed on the display portion DA regardless of whether the observer's face to the display portion DA is in the front orientation or the side orientation. This first display mode is also referred to as “lateral mode”. In the second display mode, as shown in FIG. 14, a stereoscopic image having a longitudinal motion parallax can be observed regardless of whether the observer's face to the display portion DA is in the front orientation or the side orientation. This second display mode is also referred to as “longitudinal mode”.

Even if the image corresponding to the first display mode (referred to as a first image) and the image corresponding to the second display mode (referred to as a second image) are the same display target, the information of each pixel is different. The first image is an image for lateral observation that matches the movement of the observer's line of sight in the lateral direction (X-X′ direction), and the information of each pixel corresponding to the left side and the right side of the image is detailed. The second image is an image for longitudinal observation in accordance with the movement of the observer's line of sight in the longitudinal direction (the Y-Y′ direction), and the information of each pixel corresponding to the upper side and the right side of the image is detailed. That is, the first image and the second image have different information on each pixel corresponding to the upper, lower, right or left side of the image greatly affected by the line of sight. In contrast, the information of each pixel corresponding to the central part of the image that is not so much affected by the line of sight is substantially the same.

### Tilt Angle of Light control controller

FIG. 15 is a diagram illustrating a tilt angle θ3 of a light control controller 100 to the display portion DA. FIG. 16 is a table showing a relationship between the tilt angle θ3 of the light control controller 100 and moire.

A state in which the display portion DA is set in lateral orientation, i.e., a state in which the first direction X of the display portion DA is the vertical direction and the second direction Y is the horizontal direction as shown in FIG. 15 will be described. In the figure, “lateral” represents the orientation along the second direction Y of the display portion DA, and “longitudinal” represents the orientation along the first direction X of the display portion DA. In the display portion DA, a plurality of sub-pixels SP are arranged in a matrix in the first direction X and the second direction Y. When the display portion DA is in lateral orientation, the longer sides of each sub-pixel SP extend along the second direction Y. As described with reference to FIG. 9, the sub-pixels SP of different colors are arranged in the first direction X of the display portion DA, and the sub-pixels SP of the same color are arranged in the second direction Y of the display portion DA. The second width WY of the sub-pixel SP is n times as large as the first width WX. In this example, n=3 and the second width WY is approximately three times as large as the first width WX.

The tilt angle θ3 of the light control controller 100 is set to an angle at which the image displayed on the display portion DA can be stereoscopically viewed in two directions orthogonal to each other, i.e., the first direction X and the second direction Y and is approximately 45 degrees. Incidentally, in the example of FIG. 15, the tilt of the light control controller 100 is leftwardly downward, but may be rightwardly downward.

The sub-pixels SP are arranged in a matrix in the first direction X and the second direction Y, and moire may occur in the image depending on the tilt angle θ3 of the light control controller 100. The example of FIG. 16 indicates the result of measuring the state of moire by changing the angle θ3 at the ratio of the number of “lateral” pixels and the number of “longitudinal” sub-pixels. The notation “x” indicates that the moire is clearly visible and is NG. The notation “o-” indicates that the moire looks light but is OK. The notation “o” indicates that the moire is hard to see and is OK.

The following expression (1) can be obtained from the ratio of the number of “lateral” pixels to the number of “longitudinal” sub-pixels when the moire looks thin or is difficult to see.

θ3=arctan (nm/k) (1)

However, n is the number of sub-pixels forming one pixel and m is a natural number of 1 or more. k is a prime number and is desirably 13 or less. That is, k corresponds to the number of “longitudinal” sub-pixels when the moire looks thin in the example of FIG. 16 or the moire is hard to see, and is 5, 7, 11, and 13. Incidentally, in the example shown in FIG. 9, θ3=arctan (6/5)=approximately 50 degrees, and is the angle when the number of pixels in the “lateral direction” is 2 (the number of sub-pixels is 6) and the number of sub-pixels in the “longitudinal direction” is 5.

Thus, if the light control controller 100 is tilted at the angle θ3 that satisfies the above expression (1), the occurrence of moire can be suppressed. Therefore, the angle may be approximately 45 degrees at which the image can be viewed stereoscopically in two directions orthogonal to each other and may satisfy the above expression (1). More specifically, the light control controller 100 desirably has a tilt of 45 degrees±10 degrees with respect to the first direction X, that is, θ3=±(45 degrees±10 degrees).

### Lateral Observation and Longitudinal Observation

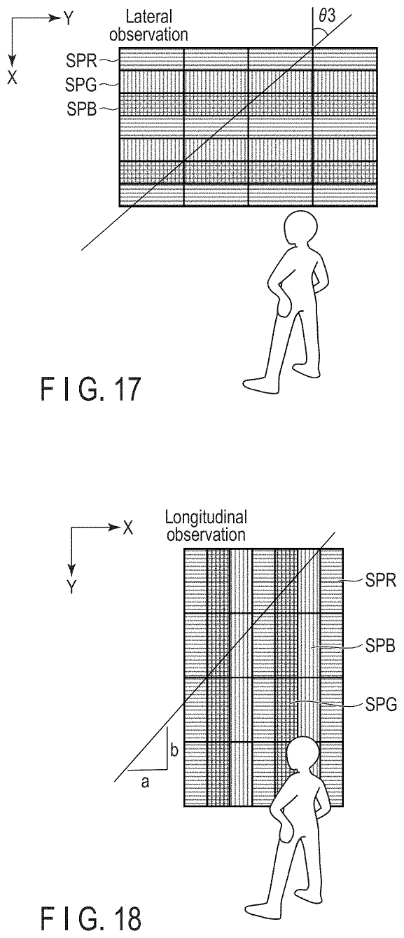

FIG. 17 is a diagram illustrating lateral observation. FIG. 18 is a diagram illustrating longitudinal observation.

In the display portion DA of the display panel 10, observing an image at an angle at which the longer side direction of the sub-pixel SP is close to the horizontal direction with respect to both eyes of the observer as shown in FIG. 17 is referred to as lateral observation. In contrast observing an image at an angle an which the longer side direction of the sub-pixel SP is close to the vertical direction with respect to both eyes of the observer as shown in FIG. 18 is referred to as longitudinal observation.

In a case of changing the longitudinal and lateral directions, when the light control controller 100 is tilted at the angle θ3 and the image is set at the angle pitch of a in the longitudinal direction, the image needs to be set at the angle pitch of b in the longitudinal observation. In a case of changing the longitudinal and lateral directions, since the light beam angle is different in the longitudinal observation and the lateral observation, the image may not be stereoscopically viewed when the light beam pitch is too different. For this reason, θ3 is desirably set to ±(45 degrees±10 degrees).

### Configuration of Display System

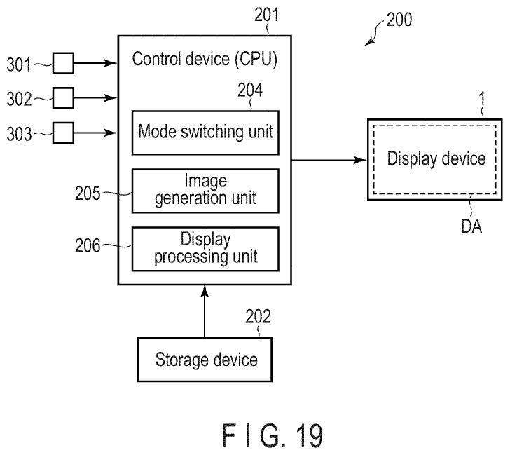

FIG. 19 is a block diagram showing a configuration of a display system. The display system 200 according to the embodiments comprises the display device 1, a control device 201, and a storage device 202. As shown in FIG. 9, the display device 1 comprises the display portion DA including a plurality of sub-pixels SP arranged in the first direction and the second direction, and the light control controller 100 overlaid on the display portion DA to control the light beams emitted from each sub-pixel SP. The light control controller 100 extends in an oblique direction different from both the first direction X and the second direction Y and is tilted at approximately 45 degrees with respect to the first direction X.

The control device 201 is composed of, for example, a CPU, and reads the program stored in the storage device 202 to control the display operation of the display device 1 according to the procedure described in the program. In the embodiments, the control device 201 includes a mode switching unit 204, an image generation unit 205, and a display processing unit 206 as functional units related to the display of stereoscopic images.

The mode switching unit 204 switches the first display mode (lateral mode) and the second display mode (longitudinal mode) described above. More specifically, the mode switching unit 204 uses at least one of a physical button 301, a tracking system 302, and a tilt detection unit 303 to switch the first display mode (lateral mode) and the second display mode (longitudinal mode).

The physical button 301 is an operation button for switching the first display mode and the second display mode according to an explicit instruction from the observer and is provided at, for example, an arbitrary position of the display device 1. The mode switching unit 204 switches the first display mode or the second display mode according to the operation of the physical button 301. Incidentally, in the example of FIG. 19, the first display mode and the second display mode are switched by the operation of one physical button 301, but the configuration is not limited to this. For example, two physical buttons may be used to switch the first display mode and the second display mode. Furthermore, the button structure may be a push type, a slide type, or a rotary type.

The tracking system 302 includes, for example, at least one of eye tracking and head tracking. “Eye tracking” detects the movement of the observer's line of sight using, for example, an infrared sensor. “Head tracking” detects the movement of the observer's head as the movement of the line of sight using, for example, a virtual reality (VR) headset. The mode switching unit 204 switches the first display mode or the second display mode according to the movement of the observer's line of sight or the movement of the observer's head detected by the tracking system 302.

The tilt detection unit 303 detects the tilt of the display portion DA of the display device 1 using, for example, a gyro sensor. The gyro sensor is built in the display device 1 and outputs an electric signal according to the tilt of the display portion DA of the display device 1. The mode switching unit 204 switches the display mode to the first display mode when it is detected by the tilt detection unit 303 that the first direction X of the display portion DA is tilted in the vertical state and the second direction Y is tilted in a state close to the horizontal direction. The mode switching unit 204 switches the display mode to the second display mode when it is detected by the tilt detection unit 303 that the first direction X of the display portion DA is tilted in the horizontal state and the second direction Y of the display portion DA is tilted in the state close to the vertical direction.

The image generation unit 205 generates the first image or the second image according to the display mode switched by the mode switching unit 204. The first image is an image for lateral observation that is used in the first display mode and matches the movement of the observer's line of sight in the lateral direction. The second image is used for the second display mode and is an image for longitudinal observation that matches the movement of the observer's line of sight in the longitudinal direction. The display processing unit 206 executes a process of displaying the first image or the second image generated by the image generation unit 205 on the display portion DA of the display device 1.

The storage device 202 incorporates programs executed by the control device (CPU) 201, and stores various types of information necessary for the processing operation of the control device 201. In addition to the operating system (OS), the programs include a program (hereinafter referred to as a display control program) for executing processing operations shown in the respective flowcharts to be described later, and the like.

A part or all parts of the mode switching unit 204, the image generation unit 205, and the display processing unit 206 are realized by causing the control device 201 to execute the display control program. This display control program may be stored in a computer-readable recording medium and distributed or may be downloaded to the control device 1 through a network. Incidentally, a part or all parts of the mode switching unit 204, the image generation unit 205, and the display processing unit 206 may be realized by hardware such as an integrated circuit (IC) or may be realized as a combination configuration of the software and hardware.

In addition, in the example of FIG. 19, the control device 201 and the storage device 202 are provided independently of the display device 1, but the control device 201 and the storage device 202 may be incorporated in the display device 1. In the configuration in which the control device 201 and the storage device 202 are independent as shown in FIG. 19, the control device 201 generates an image according to the display mode, and the display device 1 acquires this image from the control device 201 and displays the image on the display portion DA. In the configuration in which the control device 201 and the storage device 202 are provided in the display device 1, an image according to the display mode is generated in the display device 1 and the image is displayed on the display portion DA.

### Display Operation

Next, the operation of the display device 1 will be described separately for three mode switching methods 1 to 3. Incidentally, the processes shown by the following flowcharts are executed by reading the programs by the control device 201, which is a computer. As described above, the control device 201 may be provided independently of the display device 1 or may be incorporated in the display device 1.

### (1) Mode Switching Method 1

Mode switching method 1 is a method using the physical button 301. The display portion DA of the display device 1 may be in lateral or longitudinal orientation. When the display portion DA is in the lateral orientation, the display is used as described with reference to FIG. 13 and FIG. 14.

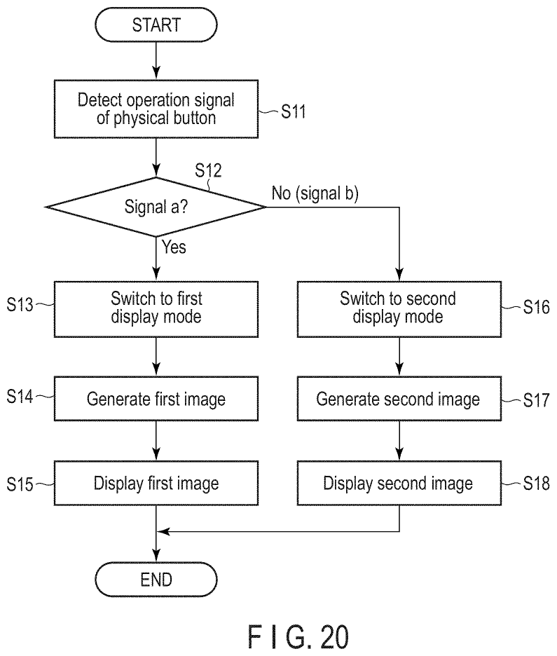

FIG. 20 is a flowchart illustrating the operation of the display device 1 according to the mode switching method 1. The control device 201 detects signal a or signal b generated when the physical button 301 is operated (step S11). The signal a is a signal for setting the first display mode. The signal b is a signal for setting the second display mode. The signal a and the signal b are selectively input to the control device 201 according to the operation of the physical button 301.

When the signal a is detected as the operation signal of the physical button 301 (Yes in step S12), the control device 201 switches the current display mode to the first display mode (step S13). In the first display mode, the control device 201 generates a first image for lateral observation that matches the movement of the observer's line of sight in the lateral direction (step S14). The control device 201 displays the first image on the display portion DA of the display device 1 (step S15).

In contrast, when the signal b is detected as the operation signal of the physical button 301 (No in step S12), the control device 201 switches the current display mode to the second display mode (step S16). In the second display mode, the control device 201 generates a second image for longitudinal observation that matches the movement of the observer's line of sight in the longitudinal direction (step S17). The control device 201 displays the second image on the display portion DA of the display device 1 (step S18).

Thus, the display mode is switched to the first display mode or the second display mode by an explicit operation using the physical button 301. In the first display mode, the first image for lateral observation is displayed on the display portion DA. Accordingly, a high-quality stereoscopic image can be observed by moving the observer's line of sight in the lateral direction. In the second display mode, the second image for longitudinal observation is displayed on the display portion DA. A high-quality stereoscopic image can be thereby observed by moving the observer's line of sight in the longitudinal direction.

### (2) Mode Switching Method 2

Mode switching method 2 is a method using the tracking system 302. Similarly to the mode switching method 1, the display portion DA of the display device 1 may be in lateral or longitudinal orientation. When the display portion DA is in the lateral orientation, the display is used as described with reference to FIG. 13 and FIG. 14.

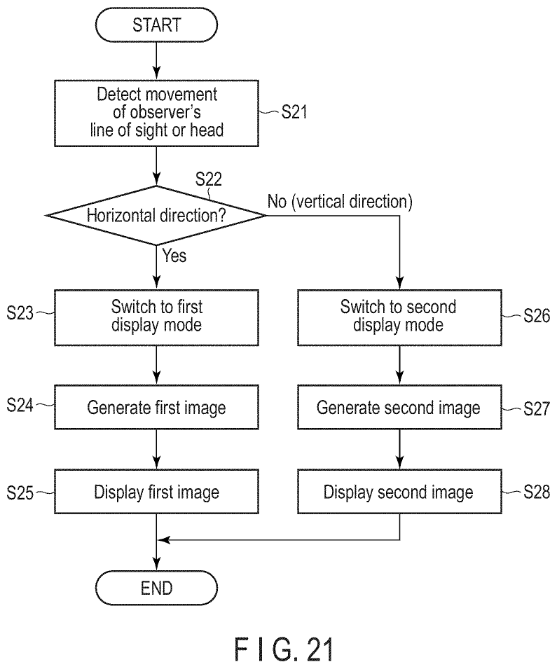

FIG. 21 is a flowchart illustrating the operation of the display device 1 according to a mode switching method 2. The control device 201 detects the observer's line of sight or the movement of the observer's face through the tracking system 302 (step S21). Incidentally, methods of detecting the observer's line of sight (eye tracking) and detecting the movement of the observer's face (head tracking) are known, and detailed description thereof will be therefore omitted here.

When a state in which the observer's line of sight or the observer's face moves in the lateral direction (horizontal direction) with respect to the display portion DA by the tracking system 302 (Yes in step S22), the control device 201 switches the current display mode to the first display mode (step S23).

Incidentally, the observer's line of sight or the observer's face may move in various directions. Therefore, it is desirable that the detection time is preliminarily allowed to have a certain time width and that the display mode is switched to the first display mode when it is detected that the observer's line of sight or the observer's face has moved in the lateral direction with respect to the display portion DA for a certain time or more. In the first display mode, the control device 201 generates a first image for lateral observation that matches the movement of the observer's line of sight in the lateral direction (step S24). The control device 201 displays the first image on the display portion DA of the display device 1 (step S25).

In contrast, when a state in which the observer's line of sight or the observer's face moves in the longitudinal direction (vertical direction) with respect to the display portion DA by the tracking system 302 (No in step S22), the control device 201 switches the current display mode to the second display mode (step S26).

Similarly to the horizontal motion detection, when a vertical movement is detected, it is desirable that the detection time is preliminarily allowed to have a certain time width and that the display mode is switched to the second display mode when it is detected that the observer's line of sight or the observer's face has moved longitudinally with respect to the display portion DA for a certain time or more. In the second display mode, the control device 201 generates a second image for longitudinal observation that matches the movement of the observer's line of sight in the longitudinal direction (step S27). The control device 201 displays the second image on the display portion DA of the display device 1 (step S28).

Thus, the first display mode or the second display mode can be switched in accordance with the movement of the observer's line of sight or the observer's face. Therefore, even if the observer is not particularly aware, a high-quality stereoscopic image can be observed by moving the line of sight or the face in the lateral direction or the longitudinal direction.

### (3) Mode Switching Method 3

Mode switching method 3 is a method using the tilt detection unit 303. Unlike the mode switching method 1 or the mode switching method 2, the display mode is switched depending on the tilt of the display portion DA of the display device 1.

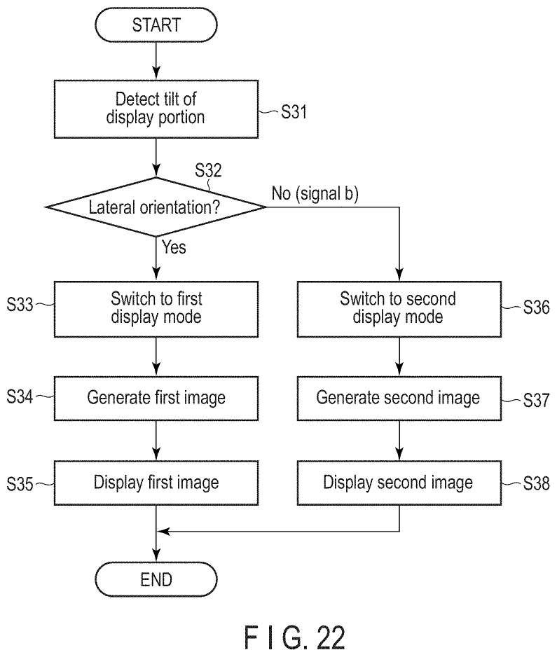

FIG. 22 is a flowchart illustrating the operation of the display device 1 according to the mode switching method 3. The control device 201 detects the tilt of the display portion DA of the display device 1 through the tilt detection unit 303 (step S31). Incidentally, the tilt detection unit 303 uses, for example, a gyro sensor, but a method of tilt detection using the gyro sensor is known, and detailed description thereof will be therefore omitted here.

When it is detected by the tilt detection unit 303 that the display portion DA is in lateral orientation (Yes in step S32), the control device 201 switches the current display mode to the first display mode (step S33). The state in which the display portion DA is in lateral direction means that the first direction X of the display portion DA is close to the vertical direction and the second direction Y is close to the horizontal direction as described in the example of FIG. 9.

Incidentally, the observer may frequently change the orientation of the display portion DA. Therefore, it is desirable that the detection time is allowed to have a certain time width and that the display mode is switched to the first display mode when it is detected that the display portion DA is in lateral orientation for a certain time or more. In the first display mode, the control device 201 generates a first image for lateral observation that matches the movement of the observer's line of sight in the lateral direction (step S34). The control device 201 displays the first image on the display portion DA of the display device 1 (step S35).

In contrast, when it is detected by the tilt detection unit 303 that the display portion DA is in longitudinal orientation (No in step S32), the control device 201 switches the current display mode to the first display mode (step S36). The state that the display portion DA is in longitudinal orientation means that the first direction X of the display portion DA is close to the horizontal direction and the second direction Y is close to the vertical direction as described in the example of FIG. 11.

Similarly to the detection of the lateral orientation of the display portion DA, it is desirable that the detection time is preliminarily allowed to have a certain time width and that the display mode is switched to the second display mode when it is detected that the display portion DA is in longitudinal orientation for a certain time or more. In the second display mode, the control device 201 generates a second image for longitudinal observation that matches the movement of the observer's line of sight in the longitudinal direction (step S37). The control device 201 displays the second image on the display portion DA of the display device 1 (step S38).

The display mode is thus switched to the first display mode when the display portion DA is tilted in lateral orientation, and to the second display mode when the display portion DA is tilted in longitudinal orientation. Since the first image for lateral observation is displayed in the first display mode, a high-quality stereoscopic image can be observed by moving the line of sight in the lateral direction (horizontal direction) of the laterally oriented display portion DA. Since the second image for longitudinal observation is displayed in the second display mode, a high-quality stereoscopic image can be observed by moving the line of sight in the longitudinal direction (vertical direction) of the longitudinally oriented display portion DA.

The above-described mode switching methods 1 to 3 can be arbitrarily selected by, for example, a selection operation on a menu screen or a button operation. When a stereoscopic image in two directions is observed by the button operation, the mode switching method 1 may be selected. When a two-dimensional stereoscopic image is observed by the line of sight or the movement of the head, the mode switching method 2 may be selected. When the two-dimensional stereoscopic image is observed by tilting the display portion DA, the mode switching method 3 may be selected.

As described above, according to the embodiments, the display device capable of improving the display quality of the stereoscopic image in the two directions, i.e., the lateral direction and the longitudinal direction can be obtained.

Incidentally, in the embodiments, L is not limited to 25, n is not limited to 3, and m is not limited to 2. For example, L may be larger than 25 or smaller than 25. Alternatively, m may be larger than 2. In addition, when the red sub-pixel SPR, the green sub-pixel SPG, the blue sub-pixel SPB, and the white sub-pixel SPW are arranged in the first direction X, n is 4. However, even when n is 4, the color combination of the sub-pixels can be variously changed.

In short, the present invention is not limited to the embodiments described above but the constituent elements of the invention can be modified in various manners without departing from the spirit and scope of the invention. Various aspects of the invention can also be extracted from any appropriate combination of constituent elements disclosed in the embodiments. For example, some of the constituent elements disclosed in the embodiments may be deleted. Furthermore, the constituent elements described in different embodiments may be arbitrarily combined.

Various types of the modified examples are easily conceivable within the category of the ideas of the present invention by a person of ordinary skill in the art and the modified examples are also considered to fall within the scope of the present invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device comprising:
a display portion including a plurality of sub-pixels arranged in a first direction and a second direction orthogonal to the first direction; and
a light control controller overlaid on the display portion to control a light beam emitted from each of the sub-pixels,
each of the sub-pixels having a first width along the first direction and a second width along the second direction, the second with being n times as large as the first width where n is a natural number of 2 or more,
the light control controller extending in an oblique direction different from the first direction and the second direction and being tilted at approximately 45 degrees to the first direction.

2. The display device of claim 1, wherein
a tilt angle to the first direction of the light control controller satisfies a condition of arctan (nm/k), n is the number of sub-pixels configuring one pixel, m is a natural number of 1 or more, and k is a prime number.

3. The display device of claim 1, wherein
the display portion switches and displays a first image for lateral observation corresponding to movement of an observer's line of sight in a lateral direction and a second image for longitudinal observation corresponding to movement of an observer's line of sight in a longitudinal direction.

4. The display device of claim 3, wherein
the first image and the second image have substantially similar information on each pixel corresponding to a central part of the image that is not affected by the line of sight.

5. The display device of claim 3, wherein
the first image and the second image have different information on each pixel corresponding to an upper, lower, right or left side of the image affected by the line of sight except a central part of the image.

6. The display device of claim 3, wherein
the display portion switches and displays the first image and the second image by an operation of a physical button.

7. The display device of claim 3, wherein
the display portion switches and displays the first image and the second image in accordance with the movement of the observer's line of sight or the observer's head.

8. The display device of claim 7, wherein
the display part displays the first image when the observer's line of sight or the observer's head moves in the lateral direction, and displays the second image when the observer's line of sight or the observer's head moves in the longitudinal direction.

9. The display device of claim 3, wherein
the display portion switches and displays the first image and the second image in accordance with tilt of the display portion.

10. The display device of claim 9, wherein
the display portion displays the first image when the first direction of the display portion is tilted in a state close to the vertical direction and the second direction is tilted in a state close to the horizontal direction, and displays the second image when the first direction of the display portion is tilted in a state close to the horizontal direction and the second direction is tilted in a state close to the vertical direction.
